(19) United States
(12) Patent Application Publication
(10) Pub. No.: US 2015/0172360 A1
(43) Pub. Date: Jun. 18, 2015

(54) CROSS-DEVICE OPERATION USING GESTURES

(71) Applicants: Heyuan Liu, Beijing (CN); Gang Chen, Beijing (CN); Yunlong He, Beijing (CN); Bin Wei, Shanghai (CN); Hong Li, Shanghai (CN)

(72) Inventors: Heyuan Liu, Beijing (CN); Gang Chen, Beijing (CN); Yunlong He, Beijing (CN); Bin Wei, Shanghai (CN); Hong Li, Shanghai (CN)

(21) Appl. No.: 13/996,474

(22) PCT Filed: Sep. 27, 2012
(86) PCT No.: PCT/CN2012/082138

§ 371 Date: Jun. 20, 2013

(51) Int. Cl. H04L 29/08; G06F 3/0484; G06F 3/0488

(52) U.S. Cl. CPC H04L 67/025; G06F 3/0488; G06F 3/04842

(57) ABSTRACT

Systems, storage medium, and methods associated with transfer of content are disclosed herein. In embodiments, a storage medium may have first and second instructions configured to facilitate operation across two computing devices. In embodiments, the first instructions may be configured to enable a source computing device to recognize a sourcing gesture of a user as a command to initiate a cross-device operation, and in response to recognition of the sourcing gesture, generate and transmit a sourcing message to initiate the cross-device operation. The second instructions may be configured to enable the target computing device to recognize a targeting gesture of the user that is complementary to the sourcing gesture, and in response to recognition of the targeting gesture, generate and transmit a targeting message to facilitate completion of the initiated cross-device operation. Other embodiments may be described and/or claimed.

### TECHNICAL FIELD

This application relates to the technical field of data processing, more specifically to methods and apparatuses associated with cross-device operations using gestures.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Many people have more than one electronic device. For example, a single person may have a mobile phone, a personal computer, a notebook, a tablet, or the like. Within a single family, even more devices may exist. As the number of electronic devices per person increase, cross-device operations may be becoming more important. Prior art devices often require a user to be familiar with and have knowledge about specific software, tools, and/or operating systems, in order to perform any cross-device operation. Thus, under the prior art, cross-device operations may be tedious and complex for most users.

### BRIEF DESCRIPTION OF THE DRAWINGS

Embodiments of the present invention will be described by way of exemplary embodiments, but not limitations, illustrated in the accompanying drawings in which like references denote similar elements, and in which:

FIG. 1 illustrates an overview of an arrangement for performing cross-device operations across two or more computing devices, including hardware elements of the computing devices;

FIG. 2 illustrates another overview of the arrangement of FIG. 1, including functional elements of the computing devices;

FIG. 3 illustrates a method for initiating a cross-device operation;

FIG. 4 illustrates a method for facilitating a cross-device operation;

FIG. 5 illustrates a method for identifying and completing an initiated cross-device operation; and

FIG. 6 illustrates an example computing device of FIG. 1; all arranged in accordance with embodiments of the present disclosure.

### DETAILED DESCRIPTION

Systems, storage medium, and methods associated with transfer of content are disclosed herein. In embodiments, a storage medium may have first and second instructions configured to facilitate operation across two or more computing devices. In embodiments, the first instructions may be configured to enable a source computing device to recognize a sourcing gesture of a user as a command to initiate a cross-device operation, and in response to recognition of the sourcing gesture, generate and transmit a sourcing message to initiate the cross-device operation. The second instructions may be configured to enable the target computing device to recognize a targeting gesture of the user that is complementary to the sourcing gesture, and in response to recognition of the targeting gesture, generate and transmit a targeting message to facilitate completion of the initiated cross-device operation.

Examples of cross-device operations may include, but are not limited to, switching consumption of content from one computing device to another computing device, continuing execution of an application from a first instance of the application on a source computing device to a second instance of the application on a target computing device, copying a file from one computing device to another computing device, and so forth.

In embodiments, these and other cross-device operations may be performed using the sourcing and targeting gestures, and the corresponding sourcing and targeting messages. The sourcing gesture may be a pinch gesture and the receiving gesture may be a reverse-pinch gesture. The sourcing and targeting messages may be matched up using a messaging matching computing device.

Accordingly, embodiments of the present disclosure may enable cross-device operations to be performed across two or more computing devices, in an easier, simpler, and/or more intuitive way.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation. Further, descriptions of operations as separate operations should not be construed as requiring that the operations be necessarily performed independently and/or by separate entities. Descriptions of entities and/or modules as separate modules should likewise not be construed as requiring that the modules be separate and/or perform separate operations. In various embodiments, illustrated and/or described operations, entities, data, and/or modules may be merged, broken into further sub-parts, and/or omitted.

The phrase “in one embodiment” or “in an embodiment” is used repeatedly. The phrase generally does not refer to the same embodiment; however, it may. The terms “comprising,” “having,” and “including” are synonymous, unless the context dictates otherwise. The phrase “A/B” means “A or B”. The phrase “A and/or B” means “(A), (B), or (A and B)”. The phrase “at least one of A, B and C” means “(A), (B), (C), (A and B), (A and C), (B and C) or (A, B and C)”.

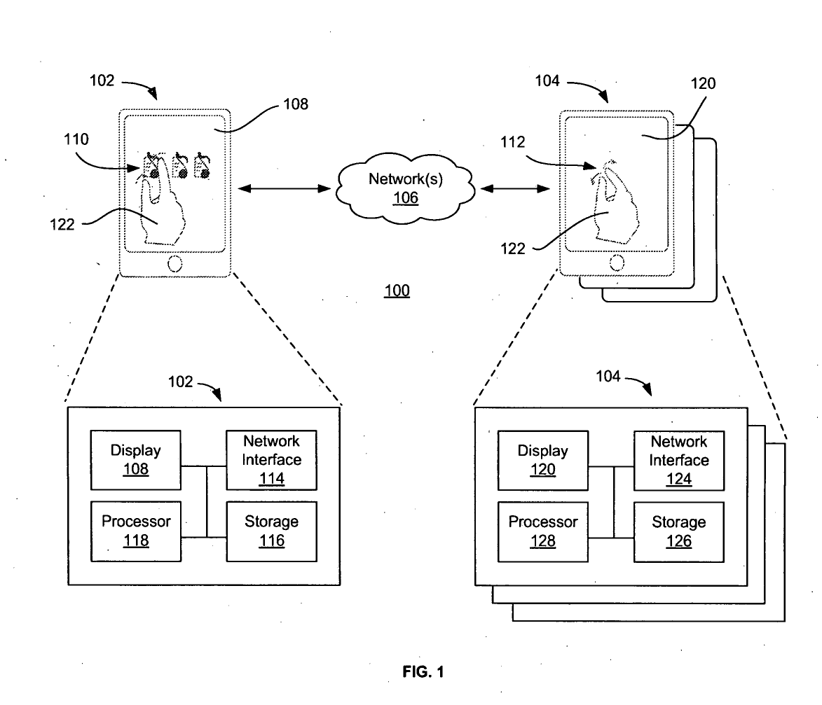

FIG. 1 illustrates an overview of an arrangement in which a cross-device operation may be performed across two or more computing devices using gestures, in accordance with various embodiments. As illustrated, arrangement 100 may include computing devices 102 and 104 configured to facilitate cross-device operations to be performed, e.g., across computing devices 102 and 104, using gestures 110 and 112. While for ease of understanding, only two computing devices 102 and 104 are shown, it will be readily apparent from the description to follow that the present disclosure may be practiced with two or more computing devices. In embodiments, a user may perform gesture 110 on computing device 102 to initiate a cross-device operation from computing device 102, and perform gesture 112 on computing device 104 to denote computing device 104 as the target computing device of the cross-device operation.

In embodiments, gestures 110 and 112 may be complementary. For example, sourcing gesture 110 may be a pinch gesture, whereas targeting gesture 112 may be a reversed-pinch gesture. Further, gesture 112 may be performed contemporaneously, having a predetermined timing relationship with gesture 110.

In embodiments, the cross-device operation may be associated with the consumption or transfer of content or execution of an application. Thus, in embodiments, gestures 110 may be performed against a display or a representation of content or an application associated with the cross-device operation, on a computing device where the cross-device operation begins. Gestures 112 may be performed on the computing device wherein the cross-device operation completes, without explicit reference to the content or application or the computing device where the cross-device operation begins.

For ease of understanding, and not limiting, hereon after, the computing device, e.g. computing device 102, where a cross-device begins may be referred to as a source computing device. The computing device, e.g. computing device 104, where a cross-device completes may be referred to as a target computing device. A computing device may be a source computing device for one cross-device operation, and a target computing device for another cross-device operation. Gestures 110 and 112 may be referred to as sourcing gesture and targeting gesture respectively.

In embodiments, cross-device operations may include a cross-device operation to switch consumption of content from computing device 102 to computing device 104. For example, computing device 102 may be a tablet while computing device 104 may be a desktop computer. A user may initially use tablet 102 to watch a movie, and may subsequently perform a cross-device operation to switch watching of the movie from tablet 102 to desktop computing device 104, using gestures 110 and 112. The user may perform gesture 110, e.g., against a scene of the movie or a representation of the movie, to initiate the switch, and subsequently, perform gesture 112 on computing device 104 to denote computing device 104 as the target computing device of the switch operation. As illustrated, gesture 112 may be performed without explicit reference to the movie or computing device 102.

Cross-device operations may also include a cross-device operation to continue execution of an application from a first instance of the application on computing device 102 to a second instance of the application on computing device 104. For example, computing device 102 may be a notebook computer while computing device 104 may be an e-reader; a user may initially use a browser on notebook computer 102 to browse a website and find a blog of interest. The user may then subsequently use a cross-device operation to enable viewing of the blog to be continued using a browser on e-reader 104, using gestures 110 and 112. The user may perform gesture 110, e.g., against a portion of the blog or a representation of the blog, to initiate the continuance, and subsequently, perform gesture 112 on computing device 104 to denote computing device 104 as the target computing device of the continuance. As illustrated, gesture 112 may be performed without explicit reference to the blog or computing device 102.

Further, cross-device operations may include a cross-device operation to copy a file from computing device 102 to computing device 104. For example, computing device 102 may be a smartphone while computing device 104 may be a notebook computer; a user may take photos using smartphone 102 and may use a cross-device operation to transfer the photos to tablet 104, using gestures 110 and 122. The user may perform gesture 110, e.g., against a portion of the photo or a representation of the photo, to initiate the transfer, and subsequently, perform gesture 112 on computing device 104 to denote computing device 104 as the target computing device of the transfer. As illustrated, gesture 112 may be performed without explicit reference to the file or computing device 102.

Before further describing the present disclosure, it should be noted that the above examples are merely illustrative and not limiting.

Still referring to FIG. 1, in embodiments, computing device 102 may include display device 108, network interface 114, storage 116, and one or more processors 118, coupled to each other as shown.

Display 108 may be any one of a number of display technologies suitable for use on a computing device. For example, display. 108 may be a liquid crystal display (LCD), a thin-film transistor LCD, a plasma display, or the like. According to various embodiments, display 108 may be a touch sensitive display, i.e., a touchscreen. As a touchscreen, display 108 may be one of a number of types of touchscreen, such as acoustic, capacitive, resistive, infrared, or the like.

Network interface 114 may be configured to couple computing device 102 to computing device 104 through one or more networks 106, hereinafter, network(s) 106. Network interface 114 may be a wireless local area network interface, such as a WiFi® interface in compliance with one of the IEEE 802.11 standards. (IEEE=Institute of Electrical and Electronics Engineers.) Network interface 114 may include a-wireless wide area network interface, such as 3G or 4G telecommunication interface. (3G and 4G refer to the 3^{rd} and 4^{th} Generation of Mobil Telecommunication Standards as defined by International Telecommunication Union.)

Storage 116 may be volatile memory, non-volatile memory, and/or a combination of volatile memory and non-volatile memory. Storage 116 may also include optical, electromagnetic and/or solid state storage. Storage 116 may store a plurality of instructions (not shown) which, when executed by processor 118, may cause computing device 102 to perform various functions related to facilitating cross-device operations, as discussed above and as will be discussed below in further detail.

One or more processors 118 (hereinafter, processor 118) may be configured to execute the plurality of instructions stored in storage 116. Processor 118 may be any one of a number of single or multi-core processors. In embodiments, in response to execution of the plurality of instructions, processor 118 may enable computing device 102 to detect gestures 110 by a user's hand 122, generate one or more messages associated with gestures 110, and transmit the one or more messages to initiate a cross-device operation, as will be described in further detail herein.

Accordingly, computing device 102, except for the functions provided to perform cross-device operation as described, may be any one of a number of computing devices known in the art, including but are not limited to, a personal digital assistant (PDA), a smartphone, a tablet computer, a laptop computer, an ultrabook, an e-reader, a game console, a media player, a set-top box, and so forth.

Computing device 104 may include display device 120, network interface 124, storage 126, and one or more processors 128, coupled with each other as shown.

Display 120 may include features similar to display 108 and may be any one of a number of types of touchscreens, according to various embodiments.

Network interface 124 may include features similar to network interface 114, according to various embodiments.

Storage 126 may include features similar to storage 116, according to various embodiments. Storage 126 may store a plurality of instructions (not shown) which, when executed by processor 128, may cause computing device 104 to perform various functions related to facilitating cross-device operations, as discussed above and as will be discussed below in further detail.

One or more processors 128 (hereinafter processor 128) may be configured to execute the plurality of instructions stored in storage 126. Processor 128 may be any one of a number of single or multi-core processors. In embodiments, in response to execution of the plurality of instructions, processor 128 may enable computing device 104 to detect gestures 112 by a user's hand 122, generate one or more messages corresponding to gestures 112 to indicate detection of a targeting gesture, and transmit the targeting message to be matched up with a complementary sourcing message, to facilitate completion of the initiated cross-device operation on target computing device 104.

Accordingly, computing device 104, except for the functions provided to perform cross-device operation as described, may be any one of a number of computing devices known in the art, including but are not limited to, a personal digital assistant (PDA), a smartphone, a tablet computer, a laptop computer, an ultrabook, an e-reader, a game console, a media player, a set-top box, and so forth.

Network(s) 106 may be configured to facilitate the cross-device operations between computing device 102 and computing device 104. Network(s) 106 may include one or more wired and/or wireless, local and/or wide area networks. Network(s) 106, as illustrated, in addition to access points, switches, and/or routers, may include one or more additional computing devices or servers, such as a device management server for managing computing devices enabled to perform cross-device operations as described, and a message server that may receive various sourcing and targeting messages transmitted by respective ones of computing devices 102 and 104, and facilitate their association.

Accordingly, consumption and/or storage of content, continuing execution of an application, and so forth, may be advantageously performed across devices, such as computing devices 102 and 104, using gestures 110 and 112. The embodied cross-device operations may be performed without understanding of the operating systems and/or system utilities of computing devices 102 and 104, and may increase cross-device usability and/or user satisfaction.

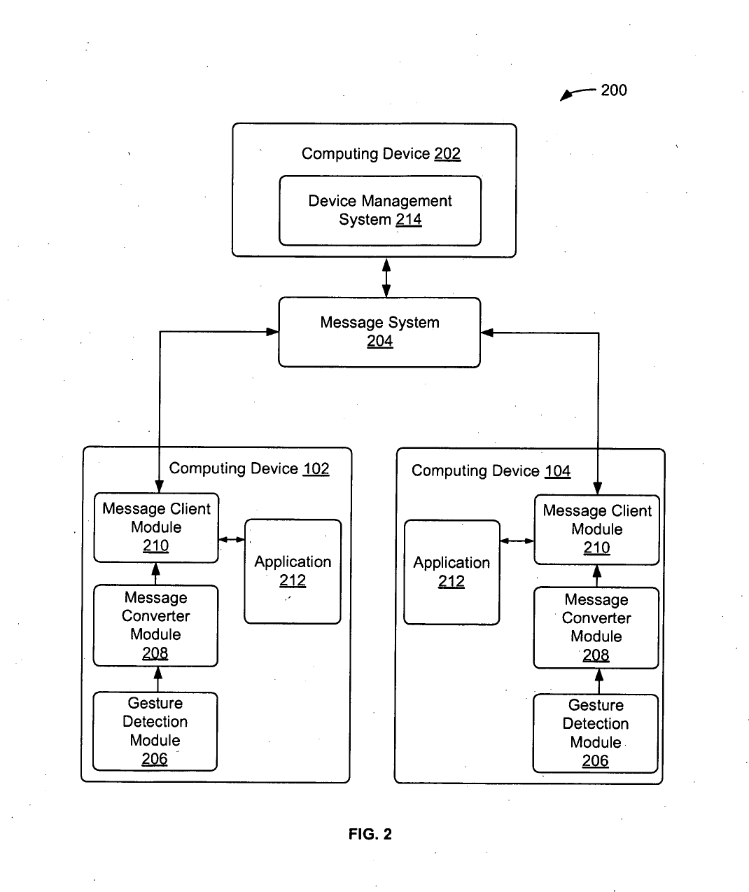

FIG. 2 illustrates another overview of the arrangement of FIG. 1, including functional elements of the computing devices, in accordance with various embodiments. For the embodiments, in addition to computing devices 102 and 104, arrangement 200 may include server computing device 202 (hereinafter, “computer server”) having a device management system 214 and message system 204, coupled with each other as shown.

Each of computing devices 102 and 104 may include modules and applications to support cross-device operations based on detected gestures as earlier described. In particular, for the embodiments, computing devices 102 and 104 may include a gesture detector module 206, a message converter module 208, a message client module 210 and one or more applications 212, operatively coupled with each other as shown.

Gesture detection module 206 may be an agent used to detect a user's gesture. Gesture detection module 206 may capture gestures and may determine if the captured gesture is a predefined gesture, such as a sourcing or targeting gesture. As described previously, sourcing and targeting gestures may be pinch and reverse-pinch gestures, respectively, according to embodiments.

If a predefined sourcing gesture is detected, gesture detection module 206 may be configured to identify and/or select the content over which the gesture is performed. According to various embodiments, the content may be an application, a media file, a text file, or the like. Gesture detection module 206 may also identify location of the application, media file, and so forth, which may be on the source computing device or at a remote location outside the source computing device. Gesture detection module 206 may then provide information to message converter module 208 about the gesture detected and/or the content or application selected.

In embodiments, if a predefined target gesture is detected, gesture detection module 206 may be configured to identify a location on the display where the gesture is detected. Gesture detection module 206 may then provide information to message converter module 208 about the gesture detected and/or the location on the display of the gesture.

Gesture detection module 206 may be implemented as part of an operating system's (OS) gesture support and/or using display 108 firmware.

Message converter module 208 may receive information from gesture detection module 206 and may use the received information to generate a message. The message may include the information about the sourcing or targeting gesture, the information about the content or application selected, and/or a location on the display where the gesture is detected. Message converter module 208 may also format the message to include device information, the gesture type (source gesture or target gesture), and information about the content. For example, while copying a music file across-devices, information about the content may be the music name, file size, and music file content. As another example, if the content is a uniform resource locator (URL), the content may be the URL. Message converter module 208 may also be referred to as message generation module or message generator.

Message client module 210 may be configured to receive messages from message converter module 208 and communicate/transmit the received messages to message system 204. Message client module 210 may be configured to receive messages from message system 204 associated with gestured detected by computing device 104. Thus, message client module 210 may also be referred to as message transmission module/transmitter or message receiving module/receiver.

According to embodiments, message client module 210 may provide messages received from message converter module 208 and/or from message system 204 to application 212. In response to receiving messages message client module 210, application 212 may update visual output rendered on one or more of displays 108 and 120. Examples of application 212 may include a music player, a video player, a file management application, a game, a browser, or the like.

Message system 204 may be an intermediate system that enables computing devices 102 and 104 to exchange information as messages via network(s) 106, such as the Internet, a local area network or wireless network, whether or not computing devices 102 and 104 can connect to each other directly. Message system 204 may be configured to connect to each computing device 102 and 104 each time computing device 102 or 104 connects to network(s) 106. Message system 204 may also establish a separate connection to computing device 102 or 104 for sending and receiving gesture-related messages.

Message system 204 may be configured to communicate with message client module 210 of computing device 102 and/or 104 via messages. For example, message system 204 may be configured to receive a message from computing device 102 that indicates that content or an application has been selected for a cross-device operation via a gesture. Message system 204 may be configured to receive a message from computing device 104 that indicates that computing device 104 has detected a gesture, identifying computing device 104 as the target computing device to complete the cross-device operation initiated by computing device 102. In response to receipt of messages, message system 204 may associate the messages. In embodiments, in addition to the gestures being complementary in movement, gesturing messages are considered to be associated when they are contemporaneously performed within a predetermined time frame, and/or the messages are transmitted within a predetermined time frame.

In embodiments, if content is involved, message system 204 may provide a message to computing device 102 or a content provider, in accordance with the information in the sourcing message, to request the content. Upon receipt of the content from computing device 102, message system 204 may provide the content to computing device 104. In alternate embodiments, message system 204 may merely relay the content location information to computing device 204, e.g., via a reply message to the targeting message. For these embodiments, target computing device 104 may provide a message to computing device 102 or a content provider, in accordance with the information in the sourcing message, to request the content instead.

In embodiments, message system 204, in lieu of being a separate independent computing device of network 106, message system 204 may be a software module resident on computing device 102, computing device 104, and/or computing server 202.

Computing server 202 may be a computing device including hardware features similar to computing devices 102 and 104. Computing server 202 may be part or all of network(s) 106 of FIG. 1. Computing server 202 may include a device management system 214.

Device management system 214 may be configured to communicate with message system 204 and configured to identify and track computing devices 102 and 104. Device management system 214 may be a system used to track ownership of computing devices 102 and 104. Device management system 214 may be configured to track networking and state information collected from software running on computing devices 102 and 104. Each user and computing devices 102 and 104 may have a unique identifier assigned by device management system 214. In embodiments, each computing device 102 and 104 may have a user as owner, and each user may be identified as owning multiple computing devices, e.g., computing devices 102 and 104.

To initiate use of arrangement 200, a user may register himself or herself and/or register each of the computing devices used by the user. The registration information may be stored by device management system 214 in addition to message system 204. The user may also associate his or her personal registration with registrations of other users, e.g., friends, so that content may be transferred and/or shared between devices registered to the user and computing devices registered to the other users. The system of arrangement 200 may be configured to store user registration information so that the user need not repeat the registration process.

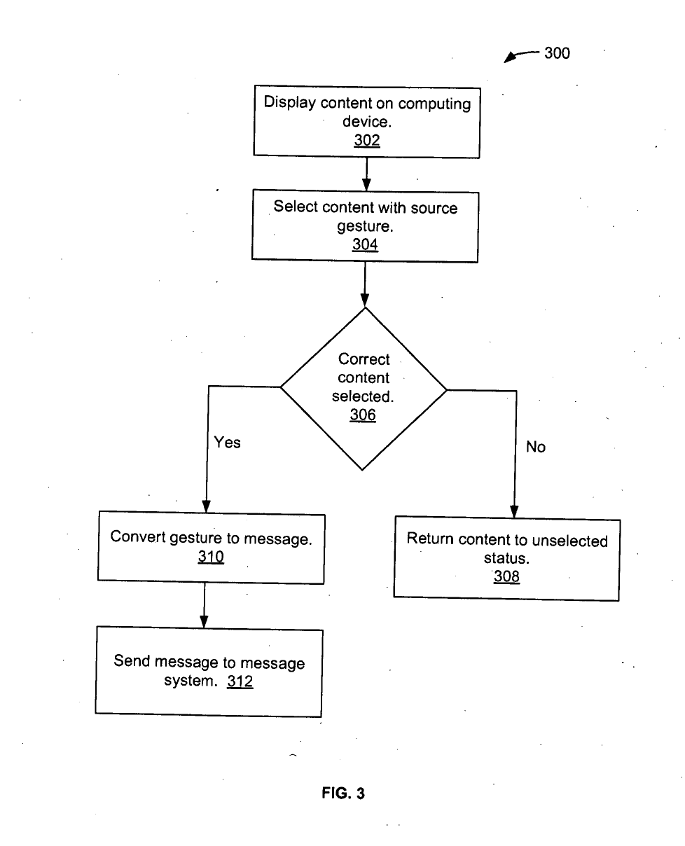

FIGS. 3-5 illustrate methods for operating various portions of the system and devices of FIGS. 1-2 to perform/facilitate cross-device operations.

FIG. 3 illustrates a method 300 for initiating a cross device operation, according to various embodiments. At block 302, content (or portion thereof, or its representation), or an output of an application (or its representation) may be displayed or rendered, e.g., by source computing device 102 on display 108. As described earlier, an example of content may be a video, a photo, a movie, and so forth. An example of an application may be a word processor, a spreadsheet application, a browser, and so forth. A representation of the content or application may be an icon.

At block 304, selection of content or application to initiate a cross-device operation may be facilitated e.g., by source computing device 102.

At block 306, a determination may be performed, e.g., by source computer device 102, on whether the selected content or application is suitable and/or authorized to be associated with a cross-device operation. For example, the digital rights management of content may prohibit the content to be transferred or copied to another computing device.

At block 308, a previously selected content or application may be unselected, e.g., by source computing device 102, if it is determined at block 306, that the content or application is ineligible or otherwise inappropriate to be associated with a cross-device operation. For example, computing device 102 may be configured to un-highlight the content or application and enable the user to gesture over other areas of display 108.

At block 310, on determining that the selected content or application is eligible or otherwise appropriate to be associated with a cross-device operation, a message may be generated, e.g., by computing device 102, to initiate the cross-device operation in association with the selected content or application. As described earlier, the message may include information about source computing device 102, the type of gesture performed, and information about the content selected. Examples of information about the content selected may include music name, music file size, music content, video title, or the text to be transferred.

At block 312, the message may be transmitted, e.g., by source computing device 102, to initiate the cross-device operation. In embodiments, the message may be transmitted to message system 204.

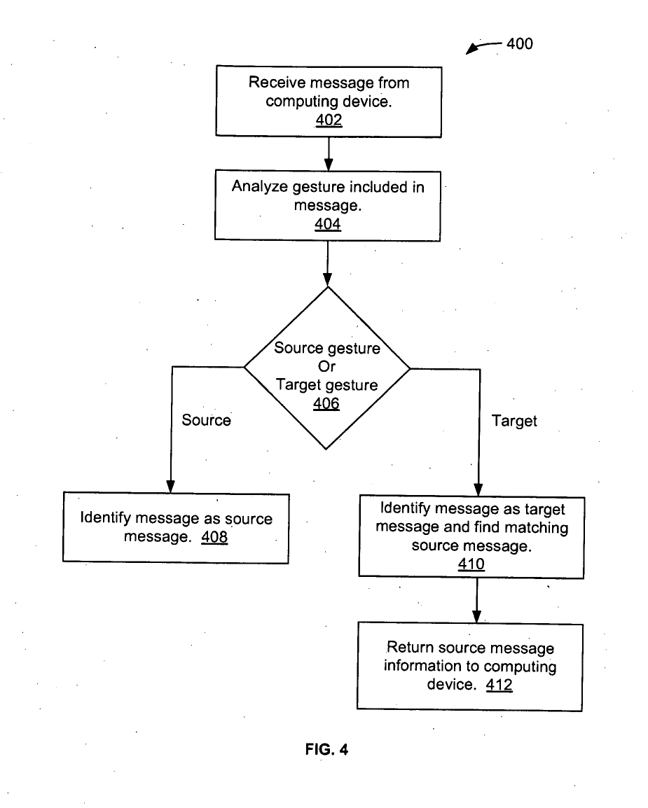

FIG. 4 illustrates a method 400 for facilitating a cross-device operation, according to various embodiments.

At block 402, a message may be received, e.g., by message system 204, from a computing device, e.g., computing device 102 or computing device 104.

At block 404, analysis may be performed, e.g., by message system 204, to determine the message type, and in particular, the gesture associated with the received message.

At block 406, a determination is performed, e.g., by message system 204, on whether the message is a sourcing message or a targeting message associated with a sourcing gesture or a targeting gesture.

At block 408, on identifying, e.g., by message system 204, that a message is a sourcing message associated with a sourcing gesture, the sourcing message may be saved/queued to wait for the complementary targeting message(s). In embodiments, the sourcing message may be saved/queued for a predetermined period of time to facilitate cross-device operations from one source computing device to multiple target computing devices. In embodiments, the sourcing message may be saved/queued for a predetermined maximum number of complementary targeting messages.

At block 410, on identifying, e.g., by message system 204, that a message is a targeting messaging associated with a targeting gesture, a search may be performed among the saved sourcing messages to locate the corresponding sourcing message. In embodiments, message system 204 may facilitate multiple cross-device operations of multiple pairs or groups of source and target computing devices.

At block 412, a message containing the relevant information about the cross-device operation, such as source computing device 102, content/application, and so forth, may be generated and transmitted, e.g., by message system 204, to target computing device 104.

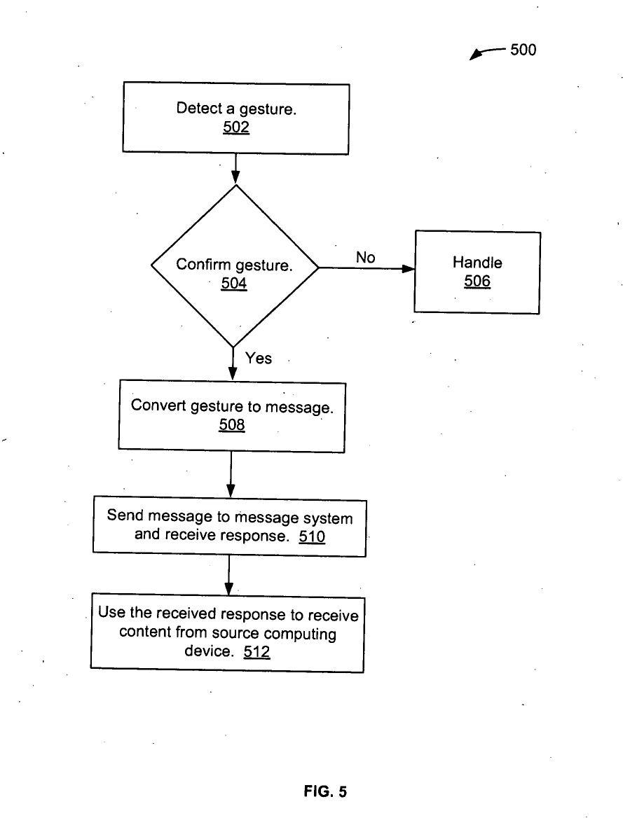

FIG. 5 illustrates a method 500 of completing a cross-device operation, according to various embodiments.

At blocks 502-504, detection of gesture and confirming a detected gesture as a targeting gesture may be facilitated, e.g., by target computing device 104. As described earlier, in embodiments, a targeting gesture may be complementary to a sourcing gesture in movement, and/or performed within a predetermined time frame. Further, a target gesture may be performed without explicit reference to the source content, application or computing device.

At block 506, if the gesture is determined, e.g., by target computing device 104, to be gestures not associated with cross-device operations, the gesture may be handled accordingly as in the prior art.

At block 508, if the gesture is determined to be a targeting gesture, a message corresponding to the detected targeting gesture may be generated, e.g., by target computing device 104.

At block 510, the targeting message corresponding to the targeting gesture may be transmitted, e.g., by target computing device 104, to be matched up with the sourcing message. In embodiments, as described earlier, the targeting message may be transmitted to message system 204.

At block 512, a reply message may be received e.g., by target computing device 104, in response to the targeting message transmitted. The reply message may include the information about the cross-device operation, including e.g., identification of content or application, location of content, and so forth, associated with the cross-device operation. In embodiments, the reply message may be received from message system 204. In response, the cross-device operation may be completed, e.g., by target computing device 104. In embodiments, completion of the cross-device operation may include continuing consumption of content, execution of another instance of an application, copying content, and so forth, on target computing device 104.

For example, the reply message may include a network address of computing device 102 and authentication information that may enable computing device 104 to request and receive the selected content from computing device 102. As another example if copying music between computing devices, the music name, file size and music content may be included in the reply message, so application 212 can use the information to create the music. Alternatively, computing device 104 may indirectly receive the content from computing device 102 through message system 204, or directly from a content provider, such as a website.

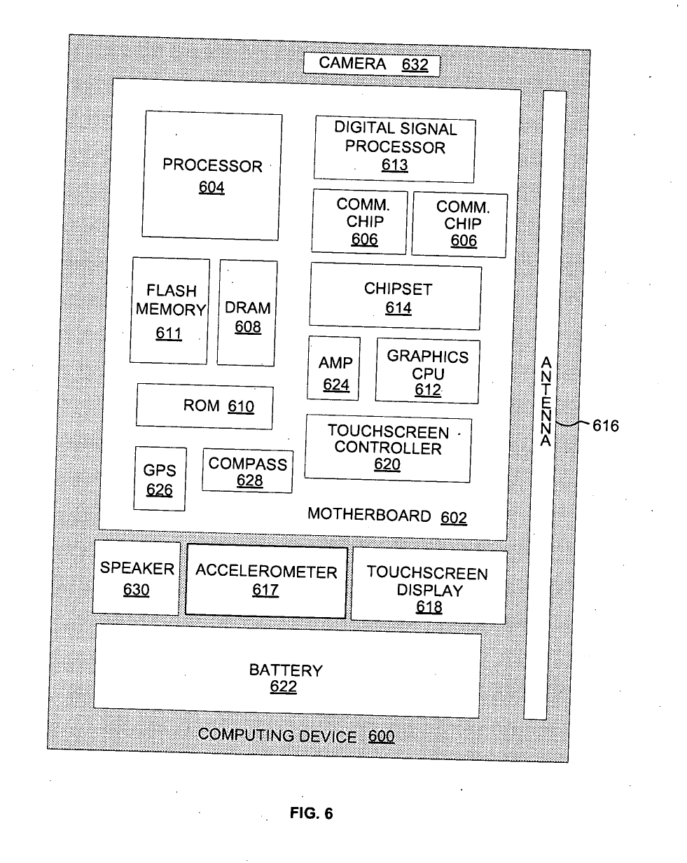

FIG. 6 illustrates an example computing device 600 in accordance with various embodiments. Depending on the actual components included, computing device 600 may be suitable for use as source computing device 102, target computing device 104, computing server 202, or message system 204 of FIGS. 1 and 2. In embodiments, computing device 600 may house a motherboard 602. Motherboard 602 may include a number of components, including but not limited to a processor 604 and at least one communication chip 606. Processor 604 may be physically and electrically coupled to motherboard 602. In some implementations the at least one communication chip 606 may also be physically and electrically coupled to motherboard 602. In further implementations, the communication chip 606 may be part of the processor 604. In alternate embodiments, the above enumerated may be coupled together in alternate manners without employment of motherboard 602.

Depending on its applications, computing device 600 may include other components that may or may not be physically and electrically coupled to motherboard 602. These other components include, but are not limited to, volatile memory (e.g., DRAM 608), non-volatile memory (e.g., ROM 610), flash memory 611, a graphics processor 612, a digital signal processor 613, a crypto processor (not shown), a chipset 614, an antenna 616, accelerometer 617, a touchscreen display 618, a touchscreen controller 620, a battery 622, an audio codec (not shown), a video codec (not shown), a power amplifier 624, a global positioning system (GPS) device 626, a compass 628, an accelerometer, a gyroscope, a speaker 630, user and away facing image capture devices 632, and a mass storage device (such as hard disk drive, compact disk (CD), digital versatile disk (DVD), and so forth).

In various embodiments, volatile memory (e.g., DRAM 608), non-volatile memory (e.g., ROM 610), and/or flash memory 611, may include instructions to be executed by processor 604, graphics processor 612, digital signal processor 613, and/or crypto processor, to practice various aspects of the methods and apparatuses described earlier with references to FIGS. 1-5 on computing device 102, computing device 104, computing server 202, and/or message system 204.

The communication chip 606 may enable wired and/or wireless communications for the transfer of data to and from the computing device 600 through one or more networks. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 606 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 600 may include a plurality of communication chips 606. For instance, a first communication chip 606 may be dedicated to shorter range wireless communications such as Wi-Fi and Bluetooth and a second communication chip 606 may be dedicated to longer range wireless communications such as GPS, EDGE, GPRS; CDMA, WiMAX, LTE, Ev-DO, and others.

The processor 604 of the computing device 600 may include an integrated circuit die packaged within the processor 604. The term “processor” may refer to any device or portion of a device (e.g., a processor core) that processes electronic data from registers and/or memory to transform that electronic data into other electronic data that may be stored in registers and/or memory.

The communication chip 606 also includes an integrated circuit die packaged within the communication chip 606.

In further implementations, another component housed within the computing device 600 may contain an integrated circuit die that includes one or more devices, such as processor cores, cache and one or more memory controllers.

In various implementations, the computing device 600 may be a laptop, a netbook, a notebook, an ultrabook, a smartphone, a tablet, a personal digital assistant (PDA), an ultra mobile PC, a mobile phone, a desktop computer, a server, a printer, a scanner, a monitor, an entertainment control unit, a digital camera, a portable music player, or a digital video recorder. In further implementations, the computing device 600 may be any other electronic device that processes data.

Thus, embodiments disclosed include, but not limited to, one or more computer-readable media having first and second instructions configured to facilitate an operation across two or more computing devices. The first instructions may be configured to, in response to execution of the instructions by a source computing device, enable the source computing device to recognize a sourcing gesture of a user as a command to initiate a cross-device operation, and in response to recognition of the sourcing gesture, generate and transmit a sourcing message to initiate the cross-device operation. The second instructions may be configured to, in response to execution of the instructions by a target computing device, enable the target computing device to recognize a targeting gesture of the user that is complementary to the sourcing gesture, and in response to recognition of the targeting gesture, generate and transmit a targeting message to facilitate completion of the initiated cross-device operation.

In embodiments, cross-device operation may include an operation to move consumption of a first content from the source computing device to the target computing device, an operation to continue execution of an application from a first instance of the application on the source computing device to a second instance of the application on the target computing device, or an operation to move a second content to the target computing device.

In embodiments, the first or second content may be located on a content provider computing device separate and distinct from the source and target computing devices.

In embodiments, the sourcing gesture may performed against a display of a portion of content, a display of the content, a display of a representation of the content, a display output of an application, or a display of a representation of the application on the sourcing computing device.

In embodiments, generate and transmit a sourcing message may include generate and transmit a sourcing message to a message matching computing device.

In embodiments, the sourcing message may include an identification of content or an application, or a description of the content including a location of the content.

In embodiments, the targeting gesture may be performed within a predetermined time frame following performance of the sourcing gesture.

In embodiments, the targeting gesture may performed without explicit reference to an object of the operation.

In embodiments, the targeting message may be transmitted within a predetermined time frame following performance of the sourcing gesture or transmission of the sourcing message.

In embodiments, generate and transmit a targeting message may include generate and transmit a targeting message to a message matching computing device.

In embodiments, the second instructions may be further configured to, in response to execution by the target computing device, enable the target computing device to receive a reply message to the targeting message that includes location information of content, and retrieve the content from a location specified by the location information.

In any of the preceding embodiments, the sourcing gesture may include a pinch gesture and the receiving gesture may include a reverse-pinch gesture.

Embodiments disclosed also may include a method for facilitating operation across computing devices. The method may include receiving and recognizing a first message as a sourcing message from a sourcing computing device to initiate a cross-device operation. The sourcing message is generated and transmitted by the sourcing computing device in response to recognition of a sourcing gesture initiating the cross-device operation by the source computing device. The method may further include receiving and recognizing a second message as a targeting message from a target computing device complementary to the sourcing message. The targeting message may be generated and transmitted by the target computing device in response to recognition of a targeting gesture complementary to the sourcing gesture by the target computing device. The method may further include, in response to the receipt and recognition of the complementary targeting message, generating and transmitting a reply message to the target message to the target computing device to facilitate completion of the cross-device operation on the target computing device.

In embodiments, the cross-device operation may include an operation to move consumption of a first content from the source computing device to the target computing device, an operation to continue execution of an application from a first instance of the application on the source computing device to a second instance of the application on the target computing device, or an operation to move a second content to the target computing device.

In embodiments, the targeting gesture may be performed within a predetermined time frame following performance of the sourcing gesture.

In embodiments, the targeting message may be transmitted within a predetermined time frame following performance of the sourcing gesture or transmission of the sourcing message.

In embodiments, the sourcing gesture may include a pinch gesture and the receiving gesture comprises a reverse-pinch gesture.

Embodiments disclosed may also include a source apparatus for performing a cross-device operation. The source apparatus may include a processor, a gesture recognition, a message generation module and a message transmission module. The gesture recognition module may be configured to be operated by the processor to recognize a sourcing gesture of a user as a command to initiate the cross-device operation. The message generation module configured to be operated by the processor to generate a sourcing message, in response to a recognition of the sourcing gesture. The message transmission module may be configured to be operated by the processor to transmit the sourcing message to source the content to initiate the cross-device operation.

In embodiments, the source apparatus may further include a display device. The sourcing gesture may be performed against a display of a portion of content, a display of the content, a display of a representation of the content, a display output of an application or a display of a representation of the application on the display device.

In embodiments, the message transmission module may be configured to transmit the sourcing message to a message matching server.

In embodiments, the sourcing message may include an identification of content or an application or a description of the content including a location of the content. The sourcing gesture may include a pinch gesture.

Embodiments disclosed may also include a target apparatus for performing a cross-device operation. The target apparatus for performing a cross-device operation may include a processor, a gesture recognition module, a message generation module, and a message transmission module.

In embodiments, the gesture recognition module configured to be operated by the processor to recognize a targeting gesture of a user;

In embodiments, the message generation module may be configured to be operated by the processor to generate a targeting message, in response to a recognition of the targeting gesture.

In embodiments, a message transmission module configured to be operated by the processor to transmit the targeting message to enable the cross-device operation to be identified and completed on the target computing device.

In embodiments, the cross-device operation may include an operation to move consumption of a first content from a source computing device to the target computing device, an operation to continue execution of an application from a first instance of the application on a source computing device to a second instance of the application on the target computing device, or an operation to move a second content to the target computing device.

In embodiments, the targeting gesture may be performed within a predetermined time frame following performance of a sourcing gesture on a source apparatus.

In embodiments, the targeting gesture may be performed without explicit reference to an object of the operation.

In embodiments, the targeting message may be transmitted within a predetermined time frame following performance of a sourcing gesture on a source apparatus or transmission of a sourcing message by the source apparatus.

In embodiments, the message transmission module may be configured to transmit the targeting message to a message matching server.

In embodiments, the apparatus may further include a message receiving module configured to receive a reply message to the targeting message, from the message matching server, that includes an identifier of content and location information of the content, and retrieve the content from a location specified by the location information.

In embodiments, the targeting gesture may include a reverse-pinch gesture.

Embodiments disclosed may also include an apparatus for performing cross-device operations. The apparatus may include a processor, a gesture recognition module, a message generation module, and a message transmission module. The gesture recognition module may be configured to be operated by the processor to recognize a sourcing gesture of a user as a command to initiate a first cross-device operation. The message generation module may be configured to be operated by the processor to generate a sourcing message, in response to a recognition of the sourcing gesture. The message transmission module may be configured to be operated by the processor to transmit the sourcing message to source the content to initiate the first cross-device operation.

In embodiments, the gesture recognition module may be further configured to be operated by the processor to recognize a targeting gesture of the user. The message generation module may be further configured to be operated by the processor to generate a targeting message, in response to a recognition of the targeting gesture. The message transmission module may be further configured to be operated by the processor to transmit the targeting message to enable a second cross-device operation to be identified and completed on the apparatus. The first and second cross-device operations may be different cross-device operations.

In embodiments, the message transmission module may be configured to transmit the sourcing message and the targeting message to a message matching server.

According to various embodiments, each of the features described for each of the computer readable media, methods, and apparatus may be combined with other features of each of the computer readable media, methods, and apparatuses.

Although specific embodiments have been illustrated and described herein, it will be appreciated by those of ordinary skill in the art that a wide variety of alternate and/or equivalent implementations may be substituted for the specific embodiments shown and described, without departing from the scope of the embodiments of the present disclosure. This application is intended to cover any adaptations or variations of the embodiments discussed herein. Therefore, it is manifestly intended that the embodiments of the present disclosure be limited only by the claims.

1. One or more non-transitory computer-readable media comprising first and second instructions configured to facilitate an operation across two or more computing devices;
wherein the first instructions are configured to, in response to execution of the instructions by a source computing device, enable the source computing device to recognize a sourcing gesture of a user as a command to initiate a cross-device operation, and in response to recognition of the sourcing gesture, generate and transmit a sourcing message to initiate the cross-device operation; and
wherein the second instructions are configured to, in response to execution of the instructions by a target computing device, enable the target computing device to recognize a targeting gesture of the user that is complementary to the sourcing gesture, and in response to recognition of the targeting gesture, generate and transmit a targeting message to facilitate completion of the initiated cross-device operation.

2. The one or more computer-readable media of claim 1, wherein the cross-device operation comprises an operation to move consumption of a first content from the source computing device to the target computing device, an operation to continue execution of an application from a first instance of the application on the source computing device to a second instance of the application on the target computing device, or an operation to move a second content to the target computing device.

3. The one or more computer-readable media of claim 2, wherein the first or second content is located on a content provider computing device separate and distinct from the source and target computing devices.

4. The one or more computer-readable media of claim 1, wherein the sourcing gesture is performed against a display of a portion of content, a display of the content, a display of a representation of the content, a display output of an application, or a display of a representation of the application on the sourcing computing device.

5. The one or more computer-readable media of claim 1, wherein generate and transmit a sourcing message comprises generate and transmit a sourcing message to a message matching computing device.

6. The one or more computer-readable media of claim 1, wherein the sourcing message comprises an identification of content or an application, or a description of the content including a location of the content.

7. The one or more computer-readable media of claim 1, wherein the targeting gesture is performed within a predetermined time frame following performance of the sourcing gesture.

8. The one or more computer-readable media of claim 1, wherein the targeting gesture is performed without explicit reference to an object of the operation.

9. The one or more computer-readable media of claim 1, wherein the targeting message is transmitted within a predetermined time frame following performance of the sourcing gesture or transmission of the sourcing message.

10. The one or more computer-readable media of claim 1, wherein generate and transmit a targeting message comprises generate and transmit a targeting message to a message matching computing device.

11. The one or more computer-readable media of claim 1, wherein the second instructions are further configured to, in response to execution by the target computing device, enable the target computing device to receive a reply message to the targeting message that includes location information of content, and retrieve the content from a location specified by the location information.

12. The one or more computer-readable media of claim 1, wherein the sourcing gesture comprises a pinch gesture and the receiving gesture comprises a reverse-pinch gesture.

13. (canceled)

14. (canceled)

15. (canceled)

16. (canceled)

17. (canceled)

18. A source apparatus for performing a cross-device operation, comprising:
a processor;
a gesture recognition module configured to be operated by the processor to recognize a sourcing gesture of a user as a command to initiate the cross-device operation;
a message generation module configured to be operated by the processor to generate a sourcing message, in response to a recognition of the sourcing gesture; and
a message transmission module configured to be operated by the processor to transmit the sourcing message to source the content to initiate the cross-device operation.

19. The source apparatus of claim 18, further comprising a display device; wherein the sourcing gesture is performed against a display of a portion of content, a display of the content, a display of a representation of the content, a display output of an application or a display of a representation of the application on the display device.

20. The source apparatus of claim 18, wherein the message transmission module is configured to transmit the sourcing message to a message matching server.

21. The source apparatus of claim 20, wherein the sourcing message comprises an identification of content or an application or a description of the content including a location of the content.

22. The source apparatus of claim 20, wherein the sourcing gesture comprises a pinch gesture.

23. A target apparatus for performing a cross-device operation, comprising:
a processor;
a gesture recognition module configured to be operated by the processor to recognize a targeting gesture of a user;
a message generation module configured to be operated by the processor to generate a targeting message, in response to a recognition of the targeting gesture; and
a message transmission module configured to be operated by the processor to transmit the targeting message to enable the cross-device operation to be identified and completed on the target computing device.

24. The target apparatus of claim 23, wherein the cross-device operation comprises an operation to move consumption of a first content from a source computing device to the target computing device, an operation to continue execution of an application from a first instance of the application on a source computing device to a second instance of the application on the target computing device, or an operation to move a second content to the target computing device.

25. The target apparatus of claim 23, wherein the targeting gesture is performed within a predetermined time frame following performance of a sourcing gesture on a source apparatus.

26. The target apparatus of claim 23, wherein the targeting gesture is performed without explicit reference to an object of the operation.

27. The target apparatus of claim 23, wherein the targeting message is transmitted within a predetermined time frame following performance of a sourcing gesture on a source apparatus or transmission of a sourcing message by the source apparatus.

28. The target apparatus of claim 23, wherein the message transmission module is configured to transmit the targeting message to a message matching server.

29. The target apparatus of claim 28, further comprising a message receiving module configured to receive a reply message to the targeting message, from the message matching server, that includes an identifier of content and location information of the content, and retrieve the content from a location specified by the location information.

30. The target apparatus of claim 23, wherein the targeting gesture comprises a reverse-pinch gesture.

31. An apparatus for performing cross-device operations, comprising:
a processor;
a gesture recognition module configured to be operated by the processor to recognize a sourcing gesture of a user as a command to initiate a first cross-device operation;
a message generation module configured to be operated by the processor to generate a sourcing message, in response to a recognition of the sourcing gesture; and
a message transmission module configured to be operated by the processor to transmit the sourcing message to source the content to initiate the first cross-device operation;
wherein the gesture recognition module is further configured to be operated by the processor to recognize a targeting gesture of the user;
wherein the message generation module is further configured to be operated by the processor to generate a targeting message, in response to a recognition of the targeting gesture;
wherein the message transmission module is further configured to be operated by the processor to transmit the targeting message to enable a second cross-device operation to be identified and completed on the apparatus;
wherein the first and second cross-device operations are different cross-device operations.

32. The apparatus of claim 31, wherein the message transmission module is configured to transmit the sourcing message and the targeting message to a message matching server.
